(19) United States
(12) Patent Application Publication
(10) Pub. No.: US 2026/0310963 A1
(43) Pub. Date: Oct. 8, 2026

(54) TECHNIQUES FOR LEVERAGING EDGE-DEPLOYED GENERATIVE AI FOR ENHANCED ASSET PERFORMANCE MANAGEMENT

(71) Applicant: SAP SE, Walldorf (DE)

(72) Inventor: Raj Prasath Subramanian, Exton, PA (US)

(21) Appl. No.: 19/098,267

(22) Filed: Apr. 2, 2025

(51) Int. Cl. G06N 3/082; G06N 3/096; G06N 5/02

(52) U.S. Cl. CPC G06N 3/082; G06N 3/096; G06N 5/02

(57) ABSTRACT

In some implementations, the techniques may include receiving a first input of a selected base model from a plurality of base models. The techniques may include receiving a second input including one or more transformer models. The techniques may include collecting domain-specific text data and curating multi-modal datasets using the selected transformer models. The technique may include labeling the domain-specific text data and the multi-modal datasets using domain-specific metadata. The techniques may include modifying the selected base model by freezing one or more large layers of the selected base model and fine-tuning one or more adapter layers of the selected base model. The techniques may include training the modified base model using the labeled domain specific text data and the labeled multi-modal datasets using a transfer learning process. The techniques may include converting the edge model into executable code and storing the executable code in a memory.

### BACKGROUND

Industrial asset management can require processing vast amounts of structured and unstructured data, including text, sensor logs, images, and videos. A challenge can be enabling reliability engineers, who may not have machine learning expertise, to access actionable insights seamlessly.

The current state of machine learning is that it is performed using cloud computing resources. The cloud computing resources that are used for computing capabilities process vast amounts of data. However, traditional cloud-based artificial intelligence (AI) can introduce latency and bandwidth costs, necessitating an edge-based, distilled AI solution for real-time operations.

The following is a partial list of some of the challenges in modern asset performance Management (APM). First, systems can have a limited contextual understanding because AI models can struggle to adapt to evolving asset behaviors in real time. Next, systems can have data accessibility gaps because reliability engineers and maintenance planners lack contextual insights for real-time decision-making. Systems can experience data overload because Industrial Internet of Things (IIoT) devices can generate massive, diverse data streams that are difficult to process centrally. Systems can experience latency issues because critical decision-making (e.g., predictive maintenance) can require near-instant insights, which centralized AI can fail to deliver. Finally, systems can include edge constraints because large AI models are difficult to deploy on edge devices due to hardware limitations (processing power, memory, energy efficiency).

There is a need for techniques that distill AI models for domain-specific understanding while ensuring efficient execution at the edge. By processing data at the edge, any feedback or alerts provided to users (e.g., reliability engineers) can be more efficient, especially for time-sensitive tasks. These new systems can dynamically identify data modalities (e.g., video, image, text, and sensor data) and can route them to optimal models for processing.

### SUMMARY

A system of one or more computers can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

The proposed system introduces an edge-deployed distilled generative AI Agent, which integrates multiple distilled models (both generative and task-specific) to enhance asset performance management using several features. One feature can include real-time decision-making by processing numerical and contextual data at the edge to ensure immediate, actionable insights. Another feature can include task-oriented intelligence by orchestrating between traditional AI models and lightweight, domain-specific large language models (LLMs) to optimize tasks like anomaly detection, forecasting, and resource allocation. Another feature can include efficient edge deployment by leveraging knowledge distillation to shrink large generative AI models, enabling their deployment on resource-constrained edge devices without compromising performance. Another feature can include hybrid input handling by combining generative AI's ability to interpret unstructured text with numerical analysis models for tasks like predictive maintenance, asset optimization, and performance evaluation. Finally, another feature can include scalable orchestration by dynamically routing tasks to the most relevant models using intent recognition and context parsing at the edge.

One aspect of the disclosure includes multi-modal, multi-model edge deployment that can seamlessly integrate multiple lightweight, task-optimized generative AI models with traditional numerical AI models at the edge, enabling real-time, hybrid data processing. This allows for handling mixed data types (numerical+contextual text) locally, minimizing reliance on centralized systems.

Another aspect of the disclosure can include distillation-powered efficiency that can implement a novel pipeline for distilling large LLMs into smaller, edge-compatible models while retaining their contextual understanding and reasoning capabilities. This can enable advanced generative AI to function within the constraints of edge devices without sacrificing accuracy or response time.

Another aspect of the disclosure can include dynamic task-oriented orchestration that can introduce a dynamic orchestration layer that routes data based on type, task intent, and resource availability, ensuring the optimal model is invoked for each scenario. This can enhance adaptability and efficiency, especially in environments with varying data patterns and performance requirements.

A third aspect of the disclosure includes enhanced asset management applications that can extend generative AI capabilities beyond standard natural language processing by leveraging numerical data and task-specific models for asset-related operations such as: predictive maintenance scheduling, asset lifecycle forecasting, and real-time key performance indicator (KPI) tracking and anomaly detection. The impact can include improving operational efficiency, reducing downtime, and enhancing decision-making for asset-intensive industries.

Finally, another feature can include edge-centric scalability that provides a scalable framework designed for heterogeneous edge environments, accommodating diverse edge device capabilities and infrastructure constraints. This can offer a future-proof solution for large-scale industrial IoT deployments.

In one general aspect, the disclosed techniques can include receiving a first input comprising a selection of a base model from a plurality of base models. The techniques can include receiving a second input comprising a selection of one or more transformer models. The techniques can include collecting domain-specific text data. The techniques can include curating multi-modal datasets using the one or more selected transformer models. The techniques can include labeling domain-specific text data and multi-modal datasets using domain-specific metadata.

The techniques can include modifying the selected base model by freezing one or more large layers of the selected base model and fine-tuning one or more adapter layers of the selected base model. The techniques can include training the modified base model using the labeled domain specific text data and the labeled multi-modal datasets using a transfer learning process. The techniques can include training an edge model using the trained, modified base model. The techniques can include converting the edge model into executable code. The techniques can include storing the executable code in a memory. Other embodiments of this aspect include corresponding computer systems, apparatus, and computer programs recorded on one or more computer storage devices, each configured to perform the actions of the methods.

Implementations may include one or more of the following features. The techniques can include selecting edge hardware configured for artificial intelligence workloads. The techniques can include deploying the executable code to the selected edge hardware. The techniques can include generating an inference engine for routing inputs dynamically to an appropriate model. The techniques can include storing the inference engine on the selected edge hardware. The techniques can include storing one or more domain-specific documents in a vector database in the edge hardware. The techniques can include retrieving relevant data from the vector database for real-time insights using retrieval-augmented process. The techniques can include generating one or more results using the edge model and retrieved relevant data. The techniques can include analyzing the results to determine one or more anomalies and generating an alert based on one or more anomalies. The techniques can include generating one or more recommendations based at least in part on the anomalies. The techniques can include sending one or more recommendations to a user. In various embodiments, the fine-tuning uses Low-Rank Adaptation. In various embodiments, the fine-tuning uses Parameter-Efficient Fine-Tuning. In various embodiments, the fine-tuning utilizes at least one of text-based diagnostics, image and video-based fault detection, and senor anomaly detection.

In another general aspect, techniques can include selecting edge hardware configured for artificial intelligence workloads. The techniques can include receiving executable code for an edge model via a network. The techniques can include deploying the executable code to the selected edge hardware. The techniques can include generating an inference engine for routing inputs dynamically to an appropriate model. The techniques can include storing the inference engine on the selected edge hardware.

Implementations may include one or more of the following features. The techniques can include storing one or more domain-specific documents in a vector database in the edge hardware. The techniques can include retrieving relevant data from the vector database for real-time insights using retrieval-augmented process. The techniques can include generating one or more results using the edge model and retrieved relevant data. The techniques can include retrieving relevant data using a retrieval-augmentation generation routine. The techniques can include analyzing the results to determine one or more anomalies. The techniques can include generating an alert based on one or more anomalies. The techniques can include generating one or more recommendations based at least in part on the anomalies. The techniques can include sending one or more recommendations to a user. In various embodiments, the inference engine receives one or more of text queries, image data, video data, and senor data. In various embodiments the techniques may include implementing a hybrid cloud-edge retrieval augmentation routing, where the edge hardware stores cached items and deeper queries are offloaded to a cloud storage. In various embodiments the techniques may include enabling on-device learning with a federated learning process.

Implementation of the described techniques may be performed by a system including various hardware components, as a method or process, or stored as a series of instructions on a computer-readable tangible medium.

The following detailed description and accompanying drawings provide a better understanding of the nature and advantages of various embodiments of the present disclosure.

### BRIEF DESCRIPTION OF THE DRAWINGS

FIG. 1 illustrates an exemplary block diagram for a system for implementing generating code for edge deployment.

FIG. 2 illustrates an exemplary block diagram for a system for deploying the generating code on an edge system.

FIG. 3 illustrates a flowchart for an exemplary process for generating code for edge deployment.

FIG. 4 a flowchart for an exemplary process deploying the generated code on an edge system.

FIG. 5 illustrates an exemplary computer system for implementing various embodiments described above.

FIG. 6 illustrates an exemplary computing device for implementing various embodiments described above.

FIG. 7 illustrates an exemplary system for implementing various embodiments described above.

### DETAILED DESCRIPTION

In the following description, for purposes of explanation, numerous examples and specific details are set forth to provide a thorough understanding of the present disclosure. It will be evident, however, to one skilled in the art that various embodiments of the present disclosure as defined by the claims may include some or all of the features in these examples alone or in combination with other features described below and may further include modifications and equivalents of the features and concepts described herein.

The proposed system addresses several key challenges in AI-driven asset management. Traditional cloud-dependent AI solutions suffer from latency, network reliability issues, and high operational costs. The contributions of this disclosure can include full knowledge distillation of multimodal AI models for real-time inference at the edge, reducing dependency on the cloud. This disclosure provides a self-adapting inference pipeline that dynamically selects and executes appropriate AI models based on the detected data modality. This disclosure enables domain-adaptive fine-tuning using parameter-efficient fine-tuning (PEFT) and Low-Rank Adaptation (LoRA), ensuring that edge-deployed models remain lightweight and continuously adaptable to new asset management scenarios. This disclosure uses an edge-based RAG strategy that ensures relevant knowledge retrieval while optimizing storage and compute constraints at the edge. These innovations collectively redefine real-time AI-driven asset monitoring and decision-making, making the system highly scalable, resource-efficient, and operationally autonomous.

This architecture ensures a scalable, efficient, and domain-adaptive AI-driven asset management system at the edge. By leveraging distilled multimodal models, PEFT and LoRA fine-tuning, RAG-based retrieval, and optimized inference techniques, the proposed system reduces dependency on the cloud, minimizes latency, and provides real-time decision support for asset-intensive industries. Future work can include further optimizing federated learning for on-device continual fine-tuning and developing adaptive RAG strategies for domain evolution.

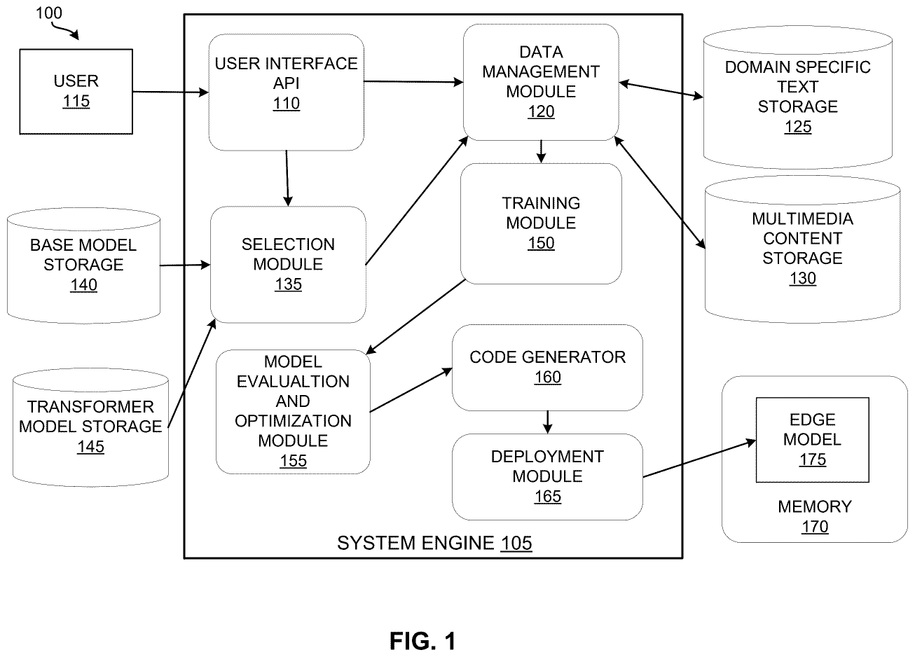

FIG. 1 illustrates an exemplary block diagram for a system 100 for implementing the techniques described herein. The system consists of various components. Distilled multimodal AI models can handle different data modalities such as: LLMs process text-based fault diagnosis and documentation retrieval, ML models analyze image and video-based defect detection, and other ML models detect anomalies in sensor data. All these models can undergo full knowledge distillation to ensure efficient edge deployment. The architecture is designed to be modular, enabling seamless integration of various AI models while maintaining real-time inference capabilities at the edge.

Fine-tuning can be achieved using PEFT and LoRA, which adapt an open-source LLM to asset management terminology and context. This approach can optimize domain-specific knowledge transfer while minimizing computational demands. Additionally, retrieval-augmented generation (RAG) indexes domain documents and sensor logs, enabling rapid retrieval of relevant information at the edge. The RAG module enhances the system's ability to provide context-aware responses, ensuring that maintenance engineers receive relevant and timely insights.

The edge deployment strategy includes a lightweight inference engine using ONNX, TensorRT, or TFLite, running on hardware equipped with AI accelerators such as TPUs, Jetson, or FPGAs. The key novelty in this architecture is the ability to seamlessly orchestrate multimodal AI inference at the edge, allowing for intelligent asset monitoring and proactive failure prevention without requiring continuous cloud connectivity.

FIG. 1 illustrates a system engine 105 for generating a machine learning model that can be executed using edge computing.

The system engine 105 can be a cloud-based machine learning model generator. The system engine 105 can be a system designed to provide users with the ability to create, train, and deploy custom machine learning (ML) models without needing to manage the underlying infrastructure. This system can be built on cloud computing resources, ensuring scalability, flexibility, and ease of use.

The cloud-based ML system consists of several components including a user interface (UI) and application programming interface (API) module 110, a data management module, a model selection and training module, a model evaluation and optimization module, a deployment and inference module, and a security and compliance module.

The UI and API module 110 can include a web-based dashboard or REST API that allows a user 115 to perform one or more of the following tasks: upload datasets, select model types (e.g., classification, regression, image recognition, NLP), customize hyperparameters, train and evaluate models, and deploy models as APIs for integration.

Data management module 120 enables cloud storage to handle large datasets (e.g., AWS S3, Google Cloud Storage, Azure Blob Storage). The data management module 120 can include data preprocessing tools to clean and normalize data. The data management module 120 can include automated feature engineering and selection tools. The data management module 120 can access (e.g., retrieve and store) domain specific text from a domain-specific text storage 125. The data management module 120 can access (e.g., retrieve and store) multimedia content from a multimedia content storage 130.

A model selection module 135 allows a user 115 through the UI & API 110 to select one or more models. The models can include prebuilt templates for common ML tasks (e.g., TensorFlow, PyTorch, Scikit-learn). In various embodiments, the model selection module 135 can include AutoML capabilities to automatically recommend and select the best model. The model selection module 135 can access one or more base models in a base model storage 140. The model selection module 135 can access one or more transformer models in a transformer model storage 145.

A training module 150 can train the selected models using one or more machine learning techniques. In various embodiments, distributed training can be performed using GPU/TPU clusters for high performance. The training module 150 can perform via hyperparameter tuning via grid search, random search, or Bayesian optimization.

Model evaluation and optimization module 155 can be used to fine tune the models according to performance metrics (e.g., accuracy, F1-score, RMSE). The model evaluation and optimization module 155 can employ one or more visualization tools for loss curves and feature importance and explainability tools (e.g., SHAP, LIME).

A code generator 160 can take the trained model and generate executable code for deployment to the edge.

A deployment and inference module 165 can provide for deployment (e.g., one click deployment) of trained models as APIs (e.g., REST or gRPC endpoints). In various embodiments, a serverless inference (e.g., AWS Lambda, Google Cloud Functions) for cost efficiency can be used. In various embodiments, the deployment can include containerized deployment via a Kubernetes/Docker. The deployment and inference module 165 can store the executable code (e.g., an edge model 175) in a memory 170.

In various embodiments, a security and compliance module can provide for data encryption and secure access controls. The security module can provide for compliance with GDPR, HIPAA, or industry-specific regulations. The security module can allow for role-based access control (RBAC) for user permissions.

In various embodiments, an auto-scaling and monitoring module can provide for real-time model monitoring with logging and alerts. The auto-scaling and monitoring module can provide auto-scaling to handle traffic spikes. The auto-scaling and monitoring module can provide for model retraining pipelines for continuous improvement.

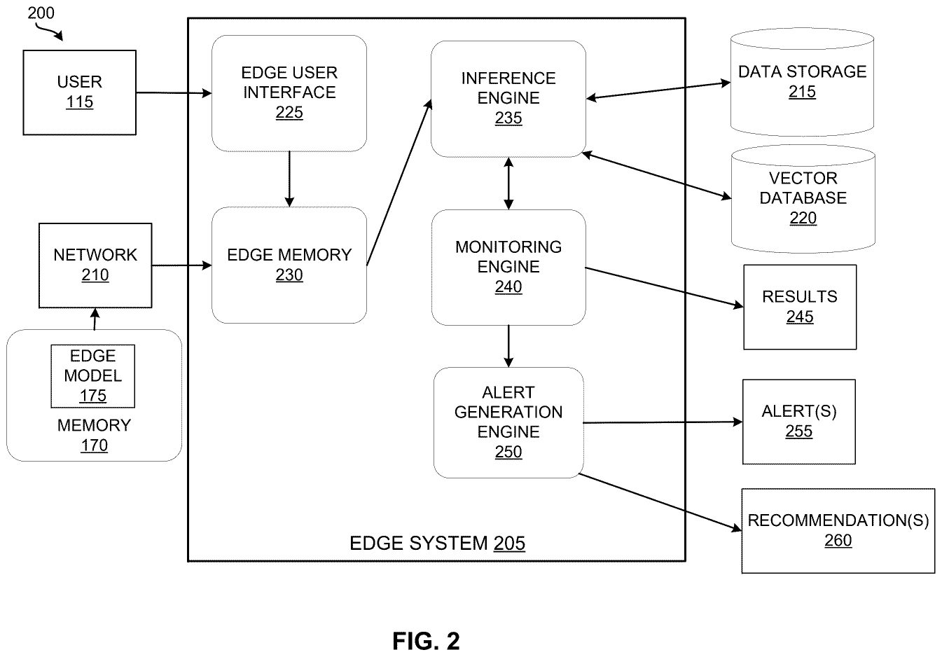

FIG. 2 illustrates edge architecture 200 include an edge computing system 205 for deploying a machine learning model that can be executed using edge computing system. An edge device can be any computing device that processes data at or near the source of data generation rather than relying on centralized cloud servers. These devices enable real-time processing, low-latency decision-making, and reduced bandwidth usage in edge computing architectures. Some exemplary edge devices can include but are not limited to Industrial IoT (IIoT) Gateways, Smart sensors and actuators, embedded systems and edge AI devices, autonomous robots and drones, edge security and networking devices.

In various embodiments, the edge architecture 200 can include a network 210, a data storage 215, and a vector database 220. The edge architecture 200 can receive an edge model 175 via a network (e.g., the Internet). The edge model can be stored in an edge memory 230 of the edge computing system 205.

The edge computing system 205 can include hardware optimized for AI workloads. Hardware optimized for artificial intelligence (AI) workloads can be designed to handle large-scale computations efficiently, particularly in areas such as deep learning, machine learning, and neural network processing.

The following list describes some characteristics of AI-optimized hardware. One characteristic can include high parallelism and specialized processing units. These units can include graphics processing units (GPUs) e.g., those produced by NVIDIA (e.g., A100, H100) and AMD. These GPUs have thousands of cores optimized for parallel computation, making them well-suited for deep learning. These units can include Tensor Processing Units (TPUs) e.g., those designed by Google. TPUs are Application-Specific Integrated Circuits (ASICs) optimized for tensor-based AI computations. These units can include Field-Programmable Gate Arrays (FPGAs) that can allow customization for AI workloads and can be reprogrammed for specific machine learning tasks. These units can include Neural Processing Units (NPUs) that can be found in some mobile and edge devices, NPUs are dedicated AI accelerators optimized for low-power inferencing.

Another characteristic of hardware optimized for AI workloads can include High Memory Bandwidth with low latency. AI models can require rapid access to large amounts of data. High-bandwidth memory (HBM) or GDDR6/7 improves efficiency. Low-latency access to memory can be important for real-time AI applications like autonomous driving or edge computing.

Another characteristic of hardware optimized for AI workloads can include efficient matrix and tensor processing. Many AI computations involve matrix multiplications (e.g., in deep learning). Hardware optimized for tensor operations (e.g., NVIDIA's Tensor Cores or Google's TPUs) accelerates these calculations.

Another characteristic of hardware optimized for AI workloads can include scalability and distributed computing support. AI workloads can require multi-GPU/multi-TPU architectures or clusters (e.g., NVIDIA NVLink, AMD Infinity Fabric). Support for distributed training across multiple nodes speeds up deep learning model training.

Another characteristic of hardware optimized for AI workloads can include precision flexibility (FP16, INT8, BF16) arithmetic features. AI chips often support lower-precision arithmetic (e.g., FP16, INT8, BF16) for faster computation with minimal accuracy loss. Lower precision allows for reduced power consumption and increased throughput in inferencing tasks.

Another characteristic of hardware optimized for AI workloads can include optimized software and framework support. AI hardware can be effective when paired with optimized libraries and frameworks. Some of these include but are not limited to CUDA & cuDNN (NVIDIA), ROCm (AMD), TensorFlow, PyTorch, ONNX Runtime, and Google's JAX for TPU acceleration. Hardware-specific software development kits (SDKs) can allow developers to optimize AI applications.

Another characteristic of hardware optimized for AI workloads can include energy efficiency and thermal management features. AI workloads are computationally expensive, requiring efficient cooling and power management. Many modern AI chips are designed with power-efficient architectures to balance performance and heat generation.

Another characteristic of hardware optimized for AI workloads can include Edge AI and On-Device Processing. AI hardware for edge devices (e.g., smartphones, IoT devices) is designed for real-time processing with minimal power usage (e.g., Apple's Neural Engine, Qualcomm's Hexagon DSP).

Another characteristic of hardware optimized for AI workloads can include fast interconnects for data movement. AI processing can involve moving large datasets quickly. High-speed interconnects (e.g., PCIe 5.0, NVLink, and CXL) can improve data transfer speeds between memory, storage, and processors.

In various embodiments edge hardware optimized for AI workloads can include but are not limited to NVIDIA Jetson (for TensorRT acceleration), Google Coral TPU (for TFLite models), Intel OpenVINO (for CPU-optimized models), and FPGAs or Edge TPUs (for power-efficient inference).

The data storage 215 can store data related to the industrial system. The data storage 215 can be a local hardware storage system (e.g., Flash memory, hard drive, etc.). The data can include but is not limited to text data, numerical data, sensor data, auditory data, image data, etc.

A vector database 220 can be a specialized type of database designed to store, index, and search high-dimensional vector representations of data. Vector databases 220 can be optimized for similarity searches, which are essential in AI, machine learning, and applications like recommendation systems, image recognition, and natural language processing (NLP).

One characteristic of a vector database 220 can include an ability to store high-dimensional vectors. Unlike traditional relational databases that store structured data (e.g., tables of numbers and text), vector databases 220 store vector embeddings that can be numerical representations of complex data (e.g., images, text, audio).

Vector databases 220 can be optimized for similarity search (e.g., Nearest Neighbor Search (NNS)). A vector database 220 can employ algorithms such as K-Nearest Neighbors (KNN), Approximate Nearest Neighbor (ANN) (e.g., HNSW, IVF), and FAISS, Annoy, ScaNN for scalable similarity search. Vector databases 220 can enable semantic search, where similar content is retrieved based on meaning rather than exact matches.

Vector databases 220 can support high-dimensional indexing. Traditional indexing methods (B-trees, hash indexes) struggle with high-dimensional spaces. Vector databases 220 can use optimized indexing structures like HNSW (Hierarchical Navigable Small World) and IVF (Inverted File Index) to speed up searches.

Vector databases 220 can integrate with AI and machine learning models. AI models (e.g., OpenAI's GPT, CLIP, BERT) generate embeddings, which are stored in vector databases 220 for fast retrieval. Vector databases 220 can be common in AI applications like chatbots, recommendation engines, and anomaly detection.

Vector databases 220 can also support scalability and distributed computing. Many vector databases 220 support distributed architectures to handle large-scale data efficiently. Some examples include but are not limited to Milvus, Weaviate, Pinecone, Vespa.

In various embodiments, the edge hardware can be set up containerized deployment using Docker or Kubernetes (K3s) for lightweight orchestration.

The edge computing system 205 can include an edge user interface 225, an edge memory 230, an inference engine 235, a monitoring engine 240, and an alert generation engine 250.

The edge user interface 225 can include a web-based dashboard or REST API that allows a user 115 to perform one or more of the following tasks: upload datasets, select model types (e.g., classification, regression, image recognition, NLP), customize hyperparameters, train and evaluate models, and deploy models as APIs for integration.

Edge devices, such as IoT gateways, industrial controllers, smart cameras, and embedded systems, use different types of memory to optimize performance, energy efficiency, and reliability for real-time processing. The edge memory 230 can store one or more edge models. In various embodiments, the edge memory 230 can store data used by the edge computing system 205. Volatile Memory (RAM-Random Access Memory) can be used for temporary storage for actively running processes and computations. Two types of RAM can include Dynamic RAM (DRAM) and Static RAM (SRAM). DRAM can be used in high-performance edge devices like industrial servers and AI accelerators. Examples can include LPDDR4 in NVIDIA Jetson, Intel Movidius.

SRAM can be used in microcontrollers and real-time processing applications for low-latency access. Some examples can include embedded SRAM in STM32 or Raspberry Pi RP2040.

Non-Volatile Memory (NVM) can be used for persistent storage for storing firmware, OS, configurations, and application data. Some NVM can include flash memory (NAND/NOR Flash), Electrically Erasable Programmable ROM (EEPROM), and SD Cards/SD Drives.

Flash memory can store firmware (OS, bootloader), logs, and software updates. Examples include eMMC/UFS in smartphones, SPI NOR Flash in microcontrollers.

EEPROM can store configuration settings and calibration data. Examples can include Industrial PLCs, automotive ECUs.

SD Cards/SSDs can be used for expandable storage for edge devices with logging or AI workloads. Examples can include Raspberry Pi SD card, NVMe SSD in edge AI servers.

Specialized Memory for AI & Edge Computing can include High-Bandwidth Memory (HBM), TPU & NPU Memory, and Magnetoresistive RAM (MRAM) and Ferroelectric RAM (FRAM). HBM can be found in AI/ML edge accelerators for rapid parallel processing. Examples can include HBM in NVIDIA Jetson Orin, Intel Habana AI processors.

TPU & NPU Memory can be optimized for neural network inference on edge AI devices. Examples can include Google Coral Edge TPU, ARM Ethos-NPU.

MRAM and FRAM can be ultra-fast, low-power memory used in industrial IoT and mission-critical systems. Examples can include Texas Instruments FRAM for real-time logging.

The inference engine 235 can route inputs dynamically. For example, text queries can pass through LLM inference engine (e.g., distilled Llama). Images and videos can be processed by vision models (ViT/CNN) for defect analysis. Sensor data can be handled by time-series models for anomaly detection.

The inference engine can optimize inference using ONNX Runtime for deep learning acceleration and TensorRT & Edge TPU API for low-latency execution.

The monitoring engine 240 can receive data from the inference engine 235. A monitoring engine 240 in an edge computing system for asset performance management (APM) plays a critical role in real-time data collection, analysis, and decision-making to optimize asset health and operational efficiency.

One function of a monitoring engine 240 in Edge APM can include real-time data collection. The monitoring engine can gather sensor data from industrial equipment, IoT devices, and machines at the edge. Data sources can include vibration sensors, temperature sensors, pressure gauges, energy meters, etc.

The monitoring engine 240 can perform edge-based data processing and analytics. The monitoring engine 240 can perform on-device or near-device computation to analyze data locally, reducing the need to send everything to the cloud. Monitoring engine 240 can use AI/ML models for predictive analytics, detecting anomalies, and preventing failures. The monitoring engine 240 can filter and compresses data to send only relevant insights to the cloud, reducing bandwidth costs.

The monitoring engine 240 can perform anomaly detection and predictive maintenance. The monitoring engine can identify patterns and anomalies indicating early signs of failure (e.g., abnormal temperature spikes, increased vibrations) as results 245. The monitoring engine 240 can predict equipment failures using machine learning models before they occur, enabling predictive maintenance.

The alert generation engine 250 can perform event triggering and automated responses. The alert generation engine 250 can send alerts 255 or automates corrective actions (e.g., adjusting operating parameters or shutting down a machine to prevent damage). The alert generation system 250 can trigger local control mechanisms to optimize asset performance without cloud dependency. In various embodiments, the alert generation engine 250 can generate one or more recommendations 260 for improved performance. The recommendations 260 can be sent to one or more engineers for system management.

The monitoring engine 240 can employ Edge AI and local decision-making. The monitoring engine 240 can integrate with AI models at the edge to make real-time operational adjustments. The monitoring engine 240 can ensure low-latency decision-making for mission-critical systems like manufacturing, power grids, or oil & gas operations. The monitoring engine 240 can seamless Integration with Cloud & Enterprise Systems. The monitoring engine 240 can sync with cloud APM platforms (e.g., AWS IoT, Azure IoT Edge, IBM Maximo) for deeper analysis and long-term insights. Monitoring engine 240 can provide APIs for integration with ERP, SCADA, and CMMS (Computerized Maintenance Management Systems).

The monitoring engine 240 can provide security and compliance management to ensure secure data transmission between edge devices and enterprise/cloud systems. The monitoring engine 240 can implement encryption, authentication, and local data storage to comply with industry regulations (e.g., HIPAA, ISO 27001).

A monitoring engine 240 in Edge APM can reduce downtime by predicting failures and optimizing maintenance schedules. A monitoring engine 240 can lower bandwidth and cloud costs by processing data locally, sending only critical insights to the cloud. The monitoring engine 240 can provide faster response time by enabling real-time decisions without waiting for cloud processing. The monitoring engine 240 can increase asset lifespan by optimizing performance and reduces wear and tear. The monitoring engine 240 can provide scalability and flexibility by working across diverse industrial assets, from factory equipment to wind turbines.

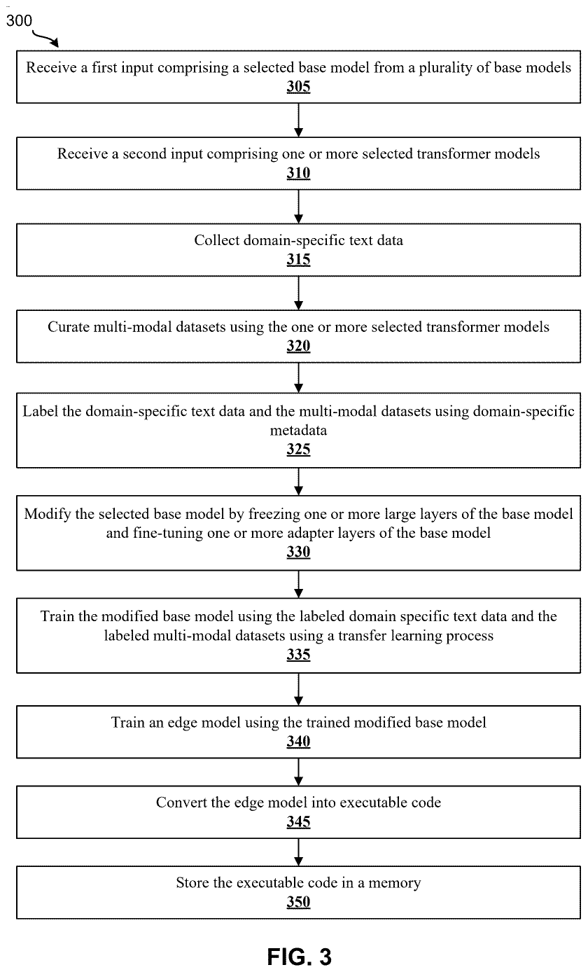

FIG. 3 is a flowchart of an example process 300 for generating an edge model. In some implementations, one or more process blocks of FIG. 3 may be performed by a computing device. The computing device can include a cloud computing resource.

As shown in FIG. 3, process 300 may include receiving, at block 305, a first input having a selected base model from a plurality of base models. For example, the computing device may receive a first input having a selected base model from a plurality of base models, as described above. The base model can include an open-source model (e.g., Mistral, Llama 3, Falcon, or other suitable foundation models.) The first input can be received using a user interface API 110 as shown in FIG. 1.

As further shown in FIG. 3, process 300 may include receiving, at block 310, a second input having one or more selected transformer models. For example, the computing device may receive a second input having one or more selected transformer models, as described above. The second input can be received using a user interface API 110 as shown in FIG. 1.

The following are one or more transformer models that can be used for text data. Transformer models for text data can include but are not limited to one or more of the following models. Bidirectional Encoder Representations from Transformers (BERT) can be context-aware word embeddings using masked language modeling. Generative Pre-trained Transformer (GPT) can use autoregressive model for text generation (GPT-2, GPT-3, GPT-4). Text-to-Text Transfer Transformer models (T5) can convert all NLP tasks into a text generation problem. XLNet can enhance BERT with permutation-based training for better performance. ELECTRA may be more efficient than BERT, replaces masked words instead of predicting them. Longformer/BigBird can be optimized for long text sequences using sparse attention. Use cases for text transformers can include machine translation, text summarization, chatbots, code generation, sentiment analysis, and question answering.

Vision transformers (ViTs) can adapt the self-attention mechanism to image processing by treating images as sequences of patches. Transformer models for images can include but are not limited to one or more of the following models. Vision Transformer (ViT) can treat images as sequences of patches, achieving state-of-the-art results on ImageNet. Data-efficient Image Transformer (DeiT) can be optimized ViT for training on smaller datasets. Swin Transformer can introduce a hierarchical structure with window-based self-attention. BERT Pretraining for Images (BEiT) can be inspired by BERT, using masked image modeling for pretraining. Segmentation Transformer (SETR) can use transformers for semantic segmentation tasks. Perceiver IO can be a generalist model capable of handling multiple modalities, including images. Use cases for image transformer models can include image classification, object detection, medical imaging, anomaly detection, image segmentation.

Videos have a temporal dimension, requiring specialized models that handle spatial-temporal relationships. Transformer models for video data can include but are not limited to one or more of the following models. Time-Space Transformer (TimeSformer) can use separate spatial and temporal attention to process videos. Video Vision Transformer (ViViT) can extend ViT to process video frames while capturing temporal dependencies. Mobile Video Networks (MoViNet) can use efficient video transformers optimized for mobile applications. Multiscale Vision Transformer (MViT) can process video at multiple spatial and temporal resolutions. Swin Video Transformer can adapt Swin Transformer for video understanding with windowed attention. Use cases for image transformer models can include action recognition, video classification, motion tracking, video anomaly detection.

As also shown in FIG. 3, process 300 may include, at block 315, collecting domain-specific text data. For example, the computing device may collect domain-specific text data, as described above.

Domain-specific text for an Industrial Asset Performance Management (APM) system refers to the specialized terminology, data structures, reports, and analytics relevant to monitoring, maintaining, and optimizing industrial assets. This text can be tailored for industries such as manufacturing, oil & gas, energy, utilities, and transportation.

Examples of domain-specific text in APM systems can include but are not limited to asset health monitoring information, predictive maintenance alerts, failure mode and root cause analysis information, work order and maintenance logs, performance metrics and key performance indicator (KPI) reports, edge computing and AI-driven insights, and compliance and safety regulation information.

Exemplary asset health monitoring can include but are not limited to: “Vibration levels on Pump 3 exceed ISO 10816 thresholds,” “Temperature anomaly detected on Motor #125—exceeds baseline by 15%,” “Remaining useful life (RUL) for Gearbox 7 estimated at 320 hours.”

Exemplary predictive maintenance alerts can include but are not limited to: “Bearing wear detected in Compressor Unit C-probability of failure: 82%,” “High moisture levels in transformer oil—potential insulation breakdown risk,” and “Scheduled maintenance required for Boiler #2 to prevent overheating.”

Failure mode and root cause analysis information can include but are not limited to: “Root cause analysis (RCA) indicates misalignment in Conveyor Belt A due to improper installation,” “Failure mode: Hydraulic system pressure loss-potential causes: seal leakage, fluid contamination,” and “Anomaly correlation: Increase in harmonic distortion aligns with motor degradation trends.”

Work order and maintenance logs can include but are not limited to: “Work Order #4592: Inspect and replace worn-out impeller blades in Centrifugal Pump 5,” “Technician Notes: Thermal imaging shows excessive heat in drive coupling-lubrication check required,” “Completed: Bearing replacement on Turbine #12—system restored to normal operating conditions.”

Performance metrics and KPI Reports can include but are not limited to: “Overall Equipment Effectiveness (OEE) for Line 4:92% (Availability: 96%, Performance: 89%, Quality: 91%),” “Mean Time Between Failures (MTBF) for Gearbox 3:1,250 hours,” “Asset Criticality Score for Substation Transformer: High-failure impact estimated at $500K.”

Edge computing and AI-driven insights can include but are not limited to: “Edge AI model detected early-stage cavitation in Centrifugal Pump 2—suggest operational adjustment,” “Digital twin analysis shows increased wear in Turbine Blade Section B—recommended inspection,” and “Machine learning model predicts motor failure within 20 days based on vibration trend deviations.”

Compliance and safety regulations can include but are not limited to “OSHA compliance check: Ensure pressure relief valves are tested per ANSI/API 576 standards,” “ISO 55000 asset management policy updated-align predictive maintenance strategy accordingly,” and “Audit log: Preventive maintenance checklist for Generator 6 completed on 2025-03-10.”

As further shown in FIG. 3, process 300 may include curating, at block 320, multi-modal datasets using the one or more selected transformer models. For example, the computing device may curate multi-modal datasets using one or more selected transformer models, as described above.

A multi-modal dataset for an Industrial Asset Performance Management (APM) system can integrate data from various sources (sensor data, images, text logs, audio, etc.) to improve asset monitoring, predictive maintenance, and operational efficiency. These datasets enable AI and machine learning models to analyze and correlate different types of asset performance data for better decision-making.

Multi-modal datasets for APM Systems can include but are not limited to time-series sensor data (e.g., IoT, SCADA, PLC). The sources for this data can include but are not limited to Industrial IoT (IIoT) devices, Supervisory Control and Data Acquisition (SCADA) systems, Programmable Logic Controllers (PLCs).

Some example data can include but are not limited to Temperature (° C.), Pressure (PSI), Vibration (mm/s), RPM, Voltage, Current, Humidity. This data can include timestamped readings from edge devices deployed in factories, power plants, oil refineries, etc.

This data can be used for predictive maintenance, anomaly detection, condition-based monitoring (CBM).

Multi-modal datasets for APM Systems can include but are not limited to Infrared/Thermal Imaging Data. The sources can include but are not limited to Infrared cameras, drones, handheld thermal scanners. The data can include but is not limited to thermal images of motors, transformers, pipelines, and rotating equipment. Pixel-level temperature heatmaps can be used to detect overheating, insulation breakdown, or energy loss. This data can be used for fault detection in electrical components, energy efficiency monitoring.

Multi-modal datasets for APM Systems can include but are not limited to Acoustic/Vibration Data. The source for this data can include acoustic sensors, accelerometers, and microphones. The example data can include but is not limited to soundwave and frequency data from rotating equipment (e.g., pumps, compressors, turbines). The data can be used for vibration spectral analysis for bearing wear, misalignment, cavitation, and mechanical looseness. The use cases can include Early failure detection using AI-driven acoustic anomaly detection.

Multi-modal datasets for APM Systems can include but are not limited to High-Resolution Image and Video Data. The sources can include but are not limited to industrial cameras, drones, robotic inspection systems. The example data can include visual inspections of cracks, corrosion, leaks, wear, and tear on equipment. The data can include but is not limited to drone footage of pipelines, wind turbines, solar panels, offshore oil rigs. Some use cases can include computer vision-based fault detection, corrosion analysis, and remote inspections.

Multi-modal datasets for APM Systems can include but are not limited to maintenance logs and work orders (Text Data). The sources can include computerized Maintenance Management Systems (CMMS), and Enterprise Asset Management (EAM) systems. Example data can include maintenance history records (e.g., “Bearing replaced in Pump 3 on 2024-06-10 due to excessive vibration”, work orders and technician notes: “Checked gearbox oil level-within operational limits.”). The use cases can include AI-driven Natural Language Processing (NLP) for maintenance predictions.

Multi-modal datasets for APM Systems can include but are not limited to energy consumption and operational data. Some sources can include smart meters and factory management systems. Some exemplary data can include real-time power consumption (kWh), fuel usage, energy efficiency metrics. The data can be used to determine load fluctuations and demand-response analytics. Some use cases can include energy optimization, sustainability reporting, and carbon footprint reduction.

Multi-modal datasets for APM Systems can include but are not limited to digital Twin and computer aided design (CAD) model data. Some sources can include digital twin platforms, Computer-Aided Design (CAD) models, simulation software. Some exemplary data can include 3D models of industrial equipment for real-time simulation and failure analysis. This data can include virtual representations of manufacturing plants, refineries, and power grids. The use cases can include virtual testing, operational optimization, and failure simulations.

Multi-modal datasets for APM Systems can include but are not limited to environmental and external condition data. Some sources can include weather stations, external sensors, satellite data. Some exemplary data can include ambient temperature, humidity, wind speed, air quality. Historical weather data can be used to determine the impact on outdoor assets (e.g., wind turbines, solar farms). Environmental data can be used for predicting environmental impact on asset performance.

Multi-modal datasets and improve accuracy of predictive maintenance by correlating multiple data sources. Multi-modal datasets can enhance root-cause analysis by integrating sensor readings, images, and maintenance logs. Use of multi-modal datasets can reduce downtime & failures by identifying patterns not visible in a single data type. Use of multi-modal datasets can optimize asset lifecycle through a data-driven, condition-based approach.

As also shown in FIG. 3, process 300 may include labeling, at block 325, the domain-specific text data and the multi-modal datasets using domain-specific metadata. For example, the computing device may label domain-specific text data and the multi-modal datasets using domain-specific metadata, as described above.

The labeling inputs can be received using a user interface API 110 as shown in FIG. 1. A user can manually enter the labels using user interface API 110.

In various embodiments, the labeling can be fully automated. Metadata for the domain-specific text data and multi-modal datasets can be used in automating labeling for GenAI models, especially in retrieval-augmented generation (RAG) and domain-specific applications like asset management. Here are a few ways to automate labeling using metadata: 1. Auto-labeling Based on Metadata Attributes; 2. Using Named Entity Recognition (NER) and Knowledge Graphs; 3. Self-Supervised Learning with Metadata; 4. Weak Supervision via Rule-Based Labeling; and 5. Retrieval-Augmented Labeling

As further shown in FIG. 3, process 300 may include, at block 330, modifying the selected base model by freezing one or more large layers of the selected base model and fine-tuning one or more adapter layers of the selected base model. For example, the computing device may modify the selected base model by freezing one or more large layers of the selected base model and fine-tuning one or more adapter layers of the selected base model, as described above.

Modifying a base model by freezing large layers and fine-tuning adapter layers can be a technique in parameter-efficient fine-tuning (PEFT). This allows efficient adaptation of pre-trained models while keeping most of the original model unchanged.

Some of the steps can include loading the pre-trained base model. In various embodiments, the model can be set to evaluation mode. The user can identify the layers to freeze (e.g., early transformer blocks, CNN backbone, etc.). This can include setting “requires_grad”=“False” for these layers to prevent weight updates during training.

Next, fine-tune adapter layers (e.g., LoRA, bottleneck adapters, or trainable projection layers) can be added and fine tuned by training only these adapter layers while keeping the frozen base layers unchanged.

In various embodiments, the fine-tuning uses Low-Rank Adaptation. In various embodiments, the fine-tuning uses Parameter-Efficient Fine-Tuning. Fine-tuning a full LLM for asset management requires significant computational resources. PEFT and LoRA can enable efficient adaptation by modifying only a small subset of model parameters. This can reduce memory and compute footprints, accelerates training time, and ensures domain-specific adaptation with limited labeled data, making it ideal for edge AI. The novel aspect of this fine-tuning approach is the ability to update the model incrementally at the edge using low-rank adaptation without retraining the entire LLM, making it highly efficient for real-time industrial applications.

As also shown in FIG. 3, process 300 may include training, at block 335, the modified base model using the labeled domain specific text data and the labeled multi-modal datasets using a transfer learning process. For example, the computing device may train the modified base model using the labeled domain specific text data and the labeled multi-modal datasets using a transfer learning processes, as described above.

The training step can perform full knowledge distillation, where a larger teacher model trains a smaller student model. The training can utilize response-based distillation in which a student model mimics the teacher's soft-label predictions. The training can utilize feature-based distillation in which the student model replicates intermediate layer representations. The training can utilize relation-based distillation in which the student model learns interactions between multiple data points.

As further shown in FIG. 3, process 300 may include training, at block 340, an edge model using the trained, modified base model. For example, the computing device may train an edge model using the trained, modified base model, as described above.

As also shown in FIG. 3, process 300 may include converting, at block 345, the edge model into executable code. For example, the computing device may convert the edge model into executable code, as described above.

In various embodiments, the following steps can be used to convert a fine-tuned model into a lightweight edge-compatible model. First, process 300 can convert the fine-tuned model to ONNX (for interoperability) by exporting the model to ONNX from PyTorch or TensorFlow. The model can be optimized using onnx-simplifier or onnxruntime-tools.

Next the model can be convert to TensorRT (for NVIDIA edge devices) by using trtexec or TensorRT Python API to convert ONNX to TensorRT engine. FP16 or INT8 quantization can be applied for efficiency.

For mobile and embedded devices the model can be convert to TensorFlow Lite (TFLite) by using tf.lite.TFLiteConverter. Process 300 can apply post-training quantization (e.g., dynamic range, full integer, or float16).

Next, process 300 can include pruning to remove unnecessary connections and quantization-aware training (QAT) for better performance.

Next the model can be optimized for edge deployment. Process 300 can include using TensorFlow Lite Delegate (e.g., EdgeTPU, NNAPI, or GPU delegate). In various embodiments the model can deploy optimized models on hardware like NVIDIA Jetson, Coral TPU, or mobile devices.

The process 300 can include converting the fine-tuned model into ONNX, TensorRT, or TFLite format. This converting process can implement quantization-aware training (QAT) or post-training quantization (PTQ) to reduce model size. The process can include pruning unnecessary layers while maintaining accuracy.

As further shown in FIG. 3, process 300 may include storing, at block 350, the executable code in a memory. For example, the computing device may store the executable code in a memory, as described above.

Process 300 may include additional implementations, such as any single implementation or any combination of implementations described below and/or in connection with one or more other processes described elsewhere herein.

In various embodiments, process 300 can include selecting edge hardware configured for artificial intelligence workloads. Process 300 can include deploying the executable code to the selected edge hardware. Process 300 can include generating an inference engine for routing inputs dynamically to an appropriate model. Process 300 can include storing the inference engine on the selected edge hardware.

In various embodiments, process 300 can include storing one or more domain-specific documents in a vector database in the edge hardware. Process 300 can include retrieving relevant data from the vector database for real-time insights using retrieval-augmented processed. Process 300 can include generating one or more results using the edge model and the retrieved relevant data.

In various embodiments, process 300 can further include analyzing the results to determine one or more anomalies. Process 300 can include generating an alert based on one or more anomalies. Process 300 can include generating one or more recommendations based at least in part on the anomalies. Process 300 can include sending one or more recommendations to a user.

In various embodiments, the fine-tuning utilizes at least one of text-based diagnostics, image and video-based fault detection, and senor anomaly detection.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

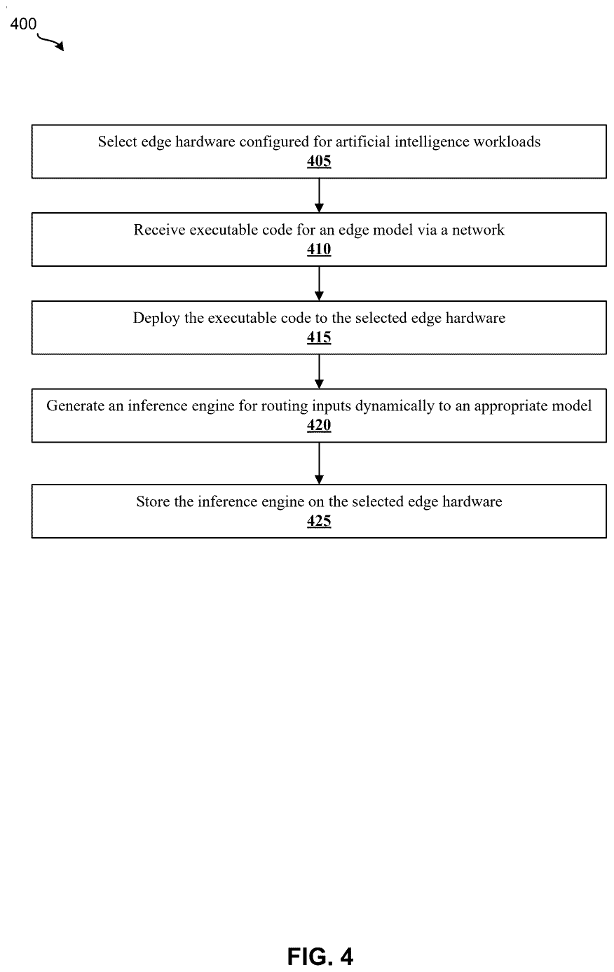

FIG. 4 is a flowchart of an example process 400 for deploying an edge model. In some implementations, one or more process blocks of FIG. 4 may be performed by a computing device.

As also shown in FIG. 4, process 400 may include selecting, at block 405, edge hardware configured for artificial intelligence workloads. For example, the computing device may allow a user to select hardware configured for artificial intelligence workloads.

As also shown in FIG. 4, process 400 may include receiving, at block 410, executable code for an edge model via a network. For example, the computing device may receive executable code for an edge model via a network (e.g., the Internet). The executable code can be stored in the edge memory 230 for the edge computing system 205.

As also shown in FIG. 4, process 400 may include deploying, at block 415, the executable code to the selected edge hardware. For example, the computing device may deploy the executable code to the selected edge hardware.

Deploying executable code to edge hardware can involve transferring and running software on edge devices, such as IoT gateways, embedded systems, or industrial controllers. Some steps to deploy the executable code to edge hardware can include code development and cross-compilation. The application can be generated in a suitable language (e.g., C/C++, Python, Rust, Go, etc.). If the edge device has a different architecture (e.g., ARM, x86, RISC-V), the code can be cross-compiled.

Next, the code can be containerized. This process can use Docker or Podman to package the application into a container and can ensure portability across different edge devices.

The executable or containerized application can be transferred to the edge device using one or more techniques (e.g., SSH & SCP (for Linux-based devices), FTP/SFTP (for industrial devices with file-based deployment), OTA (Over-the-Air) Updates using IoT platforms like AWS IoT Greengrass, BalenaCloud, or Mender.

The deployment process can use tools like Prometheus, Grafana, or Edge AI dashboards to monitor performance. If using Kubernetes at the edge, deploy via K3s or MicroK8s.

As also shown in FIG. 4, process 400 may include, at block 420, generating an inference engine for routing inputs dynamically to an appropriate model. For example, the computing device may generate an inference engine for routing inputs dynamically to an appropriate model.

As also shown in FIG. 4, process 400 may include storing, at block 425, the inference engine on the selected edge hardware. For example, the computing device may store the inference engine on the selected edge hardware.

Process 400 may include additional implementations, such as any single implementation or any combination of implementations described below and/or in connection with one or more other processes described elsewhere herein.

In various embodiments, process 400 can include storing one or more domain-specific documents in a vector database in the edge hardware. Process 400 can include retrieving relevant data from the vector database for real-time insights using retrieval-augmented processed. Process 400 can include generating one or more results using the edge model and the retrieved relevant data.

In various embodiments, process 400 can include retrieving relevant data using a retrieval-augmentation generation routine. The retrieval-augmented generation (RAG) to retrieve relevant data for real-time insights. Retrieval-Augmented Generation (RAG) is a hybrid AI approach that enhances text generation by incorporating an external retrieval mechanism. Instead of relying solely on a pre-trained model's memory, RAG fetches relevant information from an external knowledge base (e.g., databases, vector stores, or documents) to improve the accuracy, relevance, and factual consistency of responses.

The RAG process can include query processing in which a user provides a query/input (e.g., a question or prompt). The input can be pre-processed (tokenized, embedded, or contextualized). In a retrieval step, the system retrieves relevant information from an external knowledge base. Common data sources include vector databases (e.g., FAISS, Pinecone, Weaviate), document repositories (e.g., PDFs, websites, internal databases), structured databases (e.g., SQL, NoSQL). This retrieval can be done using semantic search via embeddings (e.g., OpenAI's text-embedding-ada-002).

In an augmentation step, the retrieved knowledge is added to the original query as context. The model then processes the combined input (query+retrieved knowledge).

In a generation step, a LLM (e.g., GPT-4, LLaMA, or Falcon) generates a response based on the retrieved information. This helps in producing factually grounded answers instead of relying only on the model's internal training data.

In a post-Processing and output step, the generated response is refined (e.g., re-ranked, formatted). The final response can be returned to the user.

In various embodiments, process 400 can include analyzing the results to determine one or more anomalies. Process 400 can include generating an alert based on one or more anomalies. Process 400 can include generating one or more recommendations based at least in part on the anomalies. Process 400 can include sending the one or more recommendations to a user.

RAG should be deployed at the edge when latency-sensitive document retrieval is required, when the device has sufficient storage and compute resources, or when offline operation is a priority. The novelty in this approach is that the RAG index is optimized for edge environments using domain-adaptive embeddings that are dynamically updated based on operational context. This ensures that retrieval efficiency remains high without excessive memory or compute overhead.

In various embodiments, the inference engine receives one or more of text queries, image data, video data, and senor data.

In various embodiments, process 400 can include implementing a hybrid cloud-edge retrieval augmentation routing, wherein the edge hardware stores cached items and deeper queries are offloaded to a cloud storage.

In various embodiments, process 400 can include enabling on-device learning with federated learning process.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

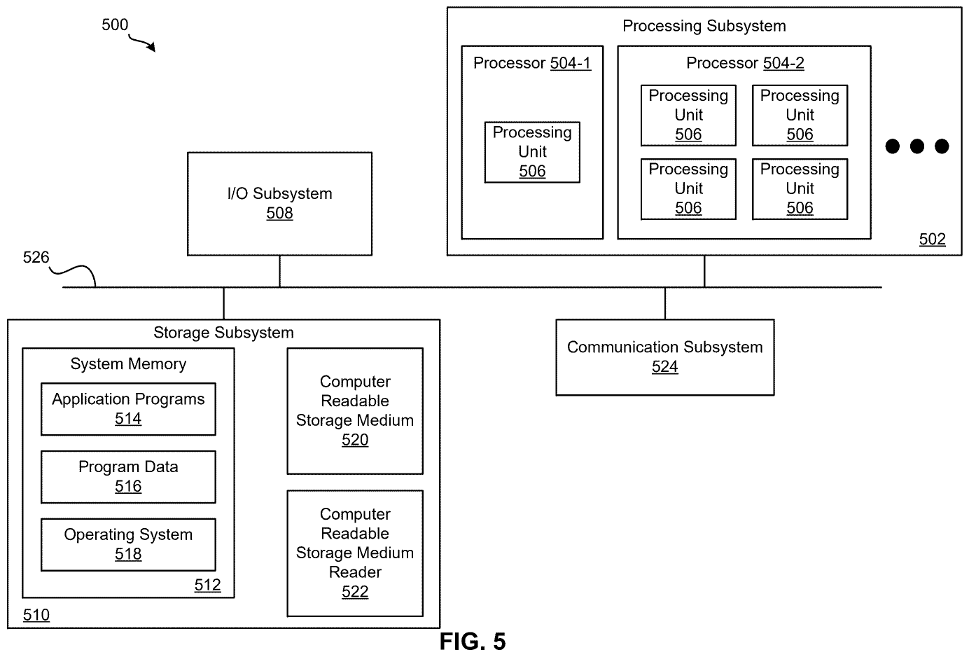

FIG. 5 illustrates a computer system 500 for implementing various embodiments described above. Computer system 500 may be a desktop computer, a laptop, a server computer, or any other type of computer system or combination thereof. In addition, computer system 500 can implement many of the operations, methods, and/or processes described above (e.g., process 300 or process 400). As shown in FIG. 5, computer system 500 includes processing subsystem 502, which communicates via bus subsystem 526, with input/output (I/O) subsystem 508, storage subsystem 510 and communication subsystem 524.

Bus subsystem 526 is configured to facilitate communication among the various components and subsystems of computer system 500. While bus subsystem 526 is illustrated in FIG. 5 as a single bus, one of the ordinary skill in the art will understand that bus subsystem 526 may be implemented as multiple buses. Bus subsystem 526 may be any of several types of bus structures (e.g., a memory bus or memory controller, a peripheral bus, a local bus, etc.) using any of a variety of bus architectures. Examples of bus architecture may include an Industry Standard Architecture (ISA) bus, a Micro Channel Architecture (MCA) bus, an Extended ISA (EISA) bus, a Video Electronics Standards Association (VESA) local bus, a Peripheral Component Interconnect (PCI) bus, a Universal Serial Bus (USB), etc.

Processing subsystem 502, which can be implemented as one or more integrated circuits (e.g., a conventional microprocessor or microcontroller), controls the operation of computer system 500. Processing subsystem 502 may include one or more processors 504. Each processor 504 may include one processing unit 506 (e.g., a single core processor such as processor 504-1) or several processing units 506 (e.g., a multicore processor such as processor 504-2). In some embodiments, processors 504 of processing subsystem 502 may be implemented as independent processors while, in other embodiments, processors 504 of processing subsystem 502 may be implemented as multiple processors integrate into a single chip or multiple chips. Still, in some embodiments, processors 504 of processing subsystem 502 may be implemented as a combination of independent processors and multiple processors integrated into a single chip or multiple chips.

In some embodiments, processing subsystem 502 can execute a variety of programs or processes in response to program code and can maintain multiple concurrently executing programs or processes. At any given time, some or all of the program code to be executed can reside in processing subsystem 502 and/or in storage subsystem 510. Through suitable programming, processing subsystem 502 can provide various functionalities, such as the functionalities described above by reference to process 300 and process 400.

I/O subsystem 508 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 500 to a user or another device (e.g., a printer).

As illustrated in FIG. 5, storage subsystem 510 includes system memory 512, computer-readable storage medium 520, and computer-readable storage medium reader 522. System memory 512 may be configured to store software in the form of program instructions that are loadable and executable by processing subsystem 502 as well as data generated during the execution of program instructions. In some embodiments, system memory 512 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 512 may include several types of memory, such as static random-access memory (SRAM) and/or dynamic random-access memory (DRAM). System memory 512 may include a basic input/output system (BIOS), in some embodiments, which is configured to store basic routines to facilitate transferring information between elements within computer system 500 (e.g., during start-up). Such a BIOS may be stored in ROM (e.g., a ROM chip), flash memory, or any other type of memory that may be configured to store the BIOS.

As shown in FIG. 5, system memory 512 includes application programs 514, program data 516, and operating system (OS) 518. OS 518 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 520 may be a non-transitory computer-readable medium configured to store software (e.g., programs, code modules, data constructs, instructions, etc.). Many of the components and/or processes (e.g., process 300 or process 400) described above may be implemented as software that when executed by a processor or processing unit (e.g., a processor or processing unit of processing subsystem 502) performs the operations of such components and/or processes. Storage subsystem 510 may also store data used for, or generated during, the execution of the software.

Storage subsystem 510 may also include computer-readable storage medium reader 522 that is configured to communicate with computer-readable storage medium 520. Together and optionally, in combination with system memory 512, computer-readable storage medium 520 may comprehensively represent remote, local, fixed, and/or removable storage devices plus storage media for temporarily and/or more permanently containing, storing, transmitting, and retrieving computer-readable information.

Computer-readable storage medium 520 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSDs), flash memory card (e.g., secure digital (SD) cards, CompactFlash cards, etc.), USB flash drives, or any other type of computer-readable storage media or device.

Communication subsystem 524 serves as an interface for receiving data from, and transmitting data to other devices, computer systems, and networks. For example, communication subsystem 524 may allow computer system 500 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 524 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 524 may provide components configured for wired communication (e.g., Ethernet) in addition to or instead of components configured for wireless communication.

One of the ordinary skill in the art will realize that the architecture shown in FIG. 5 is only an example architecture of computer system 500, and that computer system 500 may have additional or fewer components than shown, or a different configuration of components. The various components shown in FIG. 5 may be implemented in hardware, software, firmware, or any combination thereof, including one or more signal processing and/or application specific integrated circuits.

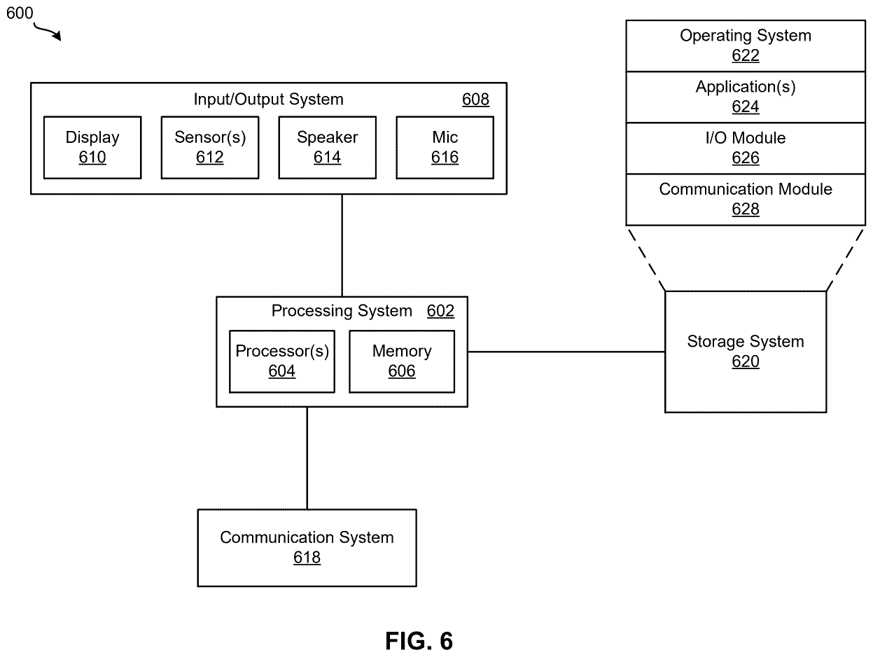

FIG. 6 illustrates an exemplary computing device 600 for implementing various embodiments described above. Computing device 600 may be a cellphone, a smartphone, a wearable device, an activity tracker or manager, a tablet, a personal digital assistant (PDA), a media player, or any other type of mobile computing device or combination thereof. In addition, computing device 600 can implement many of the operations, methods, and/or processes described above (e.g., process 300 or process 400). As shown in FIG. 6, computing device 600 includes processing system 602, input/output (I/O) system 608, communication system 618, and storage system 620. These components may be coupled by one or more communication buses or signal lines.

Processing system 602, which can be implemented as one or more integrated circuits (e.g., a conventional microprocessor or microcontroller), controls the operation of computing device 600. As shown, processing system 602 includes one or more processors 604 and memory 606. Processors 604 are configured to run or execute various software and/or sets of instructions stored in memory 606 to perform various functions for computing device 600 and to process data.

Each processor of processors 604 may include one processing unit (e.g., a single core processor) or several processing units (e.g., a multicore processor). In some embodiments, processors 604 of processing system 602 may be implemented as independent processors while, in other embodiments, processors 604 of processing system 602 may be implemented as multiple processors integrated into a single chip. Still, in some embodiments, processors 604 of processing system 602 may be implemented as a combination of independent processors and multiple processors integrated into a single chip.

Memory 606 may be configured to receive and store software (e.g., operating system 622, applications 624, I/O module 626, communication module 628, etc. from storage system 620) in the form of program instructions that are loadable and executable by processors 604 as well as data generated during the execution of program instructions. In some embodiments, memory 606 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 608 is responsible for receiving input through various components and providing output through various components. As shown for this example, I/O system 608 includes display 610, one or more sensors 612, speaker 614, and microphone 616. Display 610 is configured to output visual information (e.g., a graphical user interface (GUI) generated and/or rendered by processors 604). In some embodiments, display 610 is a touch screen that is configured to also receive touch-based input. Display 610 may be implemented using liquid crystal display (LCD) technology, light-emitting diode (LED) technology, organic LED (OLED) technology, organic electro luminescence (OEL) technology, or any other type of display technologies. Sensors 612 may include any number of several types of sensors for measuring a physical quantity (e.g., temperature, force, pressure, acceleration, orientation, light, radiation, etc.). Speaker 614 is configured to output audio information and microphone 616 is configured to receive audio input. One of the ordinary skill in the art will appreciate that I/O system 608 may include any number of additional, fewer, and/or different components. For instance, I/O system 608 may include a keypad or keyboard for receiving input, a port for transmitting data, receiving data and/or power, and/or communicating with another device or component, an image capture component for capturing photos and/or videos, etc.

Communication system 618 serves as an interface for receiving data from, and transmitting data to, other devices, computer systems, and networks. For example, communication system 618 may allow computing device 600 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 618 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 618 may provide components configured for wired communication (e.g., Ethernet) in addition to or instead of components configured for wireless communication.

Storage system 620 handles the storage and management of data for computing devices 600. Storage system 620 may be implemented by one or more non-transitory machine-readable mediums that are configured to store software (e.g., programs, code modules, data constructs, instructions, etc.) and store data used for, or generated during, the execution of the software. Many of the components and/or processes (e.g., process 300 or process 400) described above may be implemented as software that when executed by a processor or processing unit (e.g., processors 604 of processing system 602) perform the operations of such components and/or processes.

In this example, storage system 620 includes operating system 622, one or more applications 624, I/O module 626, and communication module 628. Operating system 622 includes various procedures, sets of instructions, software components and/or drivers for controlling and managing general system tasks (e.g., memory management, storage device control, power management, etc.) and facilitates communication between various hardware and software components. Operating system 622 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Applications 624 can include any number of different applications installed on computing device 600. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 626 manages information received via input components (e.g., display 610, sensors 612, and microphone 616) and information to be outputted via output components (e.g., display 610 and speaker 614). Communication module 628 facilitates communication with other devices via communication system 618 and includes various software components for handling data received from communication system 618.

One of ordinary skill in the art will realize that the architecture shown in FIG. 6 is only an example architecture of computing device 600, and that computing device 600 may have additional or fewer components than shown, or a different configuration of components. The various components shown in FIG. 6 may be implemented in hardware, software, firmware, or any combination thereof, including one or more signal processing and/or application specific integrated circuits.

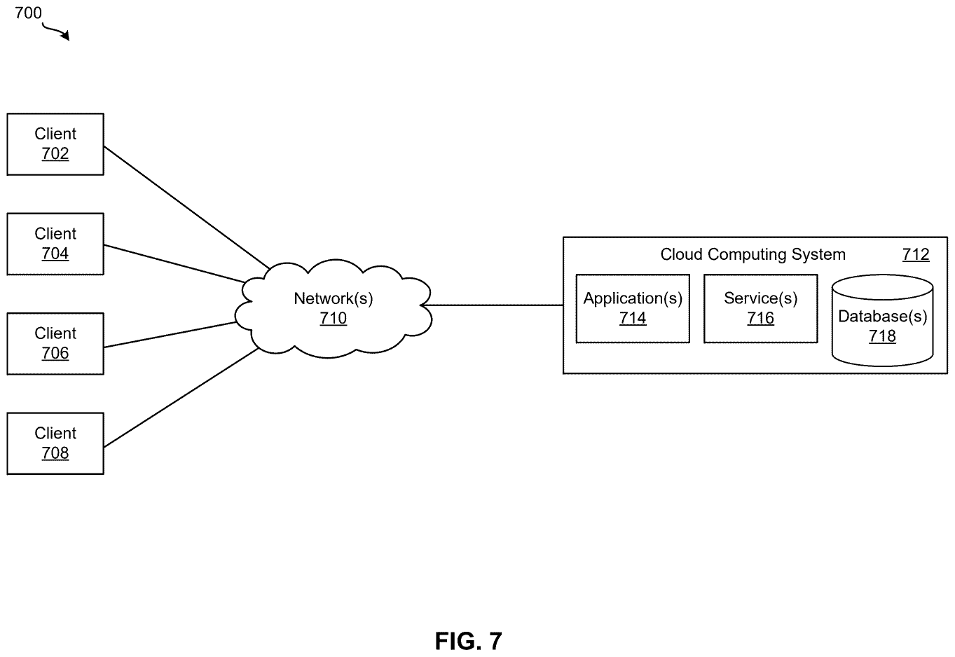

FIG. 7 illustrates an exemplary system 700 for implementing various embodiments described above. For example, any client devices 702, 704, 706, 708 may be used to implement the cloud computing system 712. As shown, system 700 includes client devices 702, 704, 706, and 708, one or more networks 710, and cloud computing system 712. Cloud computing system 712 is configured to provide resources and data to client devices 702, 704, 706, and 708 via networks 710. In some embodiments, cloud computing system 712 provides resources to any number of different users (e.g., customers, tenants, organizations, etc.). Cloud computing system 712 may be implemented by one or more computer systems (e.g., servers), virtual machines operating on a computer system, or a combination thereof.

As shown, cloud computing system 712 includes one or more applications 714, one or more services 716, and one or more databases 718. Cloud computing system 712 may provide applications 714, services 716, and databases 718 to any number of different customers in a self-service, subscription-based, elastically scalable, reliable, highly available, and secure manner.

In some embodiments, cloud computing system 712 may be adapted to automatically provision, manage, and track a customer's subscriptions to services offered by cloud computing system 712. Cloud computing system 712 may provide cloud services via different deployment models. For example, cloud services may be provided under a public cloud model in which cloud computing system 712 is owned by an organization selling cloud services and the cloud services are made available to the public or different industry enterprises. As another example, cloud services may be provided under a private cloud model in which cloud computing system 712 is operated solely for a single organization and may provide cloud services for one or more entities within the organization. The cloud services may also be provided under a community cloud model in which cloud computing system 712 and the cloud services provided by cloud computing system 712 are shared by several organizations in a related community. The cloud services may also be provided under a hybrid cloud model, which is a combination of two or more of the aforementioned different models.

In some instances, any one of applications 714, services 716, and databases 718 made available to client devices 702, 704, 706, and -708 via networks 710 from cloud computing system 712 is referred to as a “cloud service.” Typically, servers and systems that make up cloud computing system 712 are different from the on-premises servers and systems of a customer. For example, cloud computing system 712 may host an application and a user of one of client devices 702-708 may order and use the application via networks 710.

Applications 714 may include software applications that are configured to execute on cloud computing system 712 (e.g., a computer system or a virtual machine operating on a computer system) and be accessed, controlled, managed, etc. via client devices 702-708. In some embodiments, applications 714 may include server applications and/or mid-tier applications (e.g., HTTP (hypertext transfer protocol) server applications, FTP (file transfer protocol) server applications, CGI (common gateway interface) server applications, JAVA server applications, etc.). Services 716 are software components, modules, applications, etc. that are configured to execute on cloud computing system 712 and provide functionalities to client devices 702-708 via networks 710. Services 716 may be web-based services or on-demand cloud services.

Databases 718 are configured to store and/or manage data that is accessed by applications 714, services 716, and/or client devices 702-708. For instance, the customer sales data may be stored in databases 718. Databases 718 may reside on a non-transitory storage medium local to (and/or resident in) cloud computing system 712, in a storage-area network (SAN), on a non-transitory storage medium local located remotely from cloud computing system 712. In some embodiments, databases 718 may include relational databases that are managed by a relational database management system (RDBMS). Databases 718 may be a column-oriented databases, row-oriented databases, or a combination thereof. In some embodiments, some or all of databases 718 are in-memory databases. That is, in some such embodiments, data for databases 718 are stored and managed in memory (e.g., random access memory (RAM)).

Client devices 702-708 are configured to execute and operate a client application (e.g., a web browser, a proprietary client application, etc.) that communicates with applications 714, services 716, and/or databases 718 via networks 710. This way, client devices 702-708 may access the various functionalities provided by applications 714, services 716, and databases 718 while applications 714, services 716, and databases 718 are operating (e.g., hosted) on cloud computing system 712. Although system 700 is shown with four client devices, any number of client devices may be supported.

Networks 710 may be any type of network configured to facilitate data communications among client devices (e.g., first client device 702, second client device 704, third client device 706, and fourth client device 708) and cloud computing system 712 using any of a variety of network protocols. Networks 710 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments and are presented to illustrate the flexibility and advantages of various embodiments of the present disclosure as defined by the following claims. Based on the above disclosure and the following claims, other arrangements, embodiments, implementations, and equivalents will be evident to those skilled in the art and may be employed without departing from the spirit and scope of the present disclosure as defined by the claims.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or” unless explicitly stated otherwise (e.g., if used in combination with “either” or “only one of”).

What is claimed is:

1. A computer-implemented method comprising:
receiving a first input comprising a selected base model from a plurality of base models;
receiving a second input comprising one or more selected transformer models;
collecting domain-specific text data;
curating multi-modal datasets using the one or more selected transformer models;
labeling the domain-specific text data and the multi-modal datasets using domain-specific metadata;
modifying the selected base model by freezing one or more large layers of the selected base model and fine-tuning one or more adapter layers of the selected base model;
training the modified base model using the labeled domain specific text data and the labeled multi-modal datasets using a transfer learning processes;
training an edge model using the trained, modified base model;
converting the edge model into executable code; and
storing the executable code in a memory.

2. The computer-implemented method of claim 1 further comprising:
selecting edge hardware configured for artificial intelligence workloads;
deploying the executable code to the selected edge hardware;
generating an inference engine for routing inputs dynamically to an appropriate model; and
storing the inference engine on the selected edge hardware.

3. The computer-implemented method of claim 2 further comprising:
storing one or more domain-specific documents in a vector database in the edge hardware;
retrieving relevant data from the vector database for real-time insights using retrieval-augmented processed; and
generating one or more results using the edge model and the retrieved relevant data.

4. The computer-implemented method of claim 3, further comprising:
analyzing the results to determine one or more anomalies;
generating an alert based on the one or more anomalies;
generating one or more recommendations based at least in part on the anomalies; and
sending the one or more recommendations to a user.

5. The computer-implemented method of claim 1, wherein the fine-tuning uses Low-Rank Adaptation.

6. The computer-implemented method of claim 1, wherein the fine-tuning uses Parameter-Efficient Fine-Tuning.

7. The computer-implemented method of claim 1, wherein the fine-tuning utilizes at least one of text-based diagnostics, image and video based fault detection, and senor anomaly detection.

8. A non-transitory computer-readable medium storing a set of instructions, that, when executed by one or more processors of a device, cause the device to perform operations comprising:
receiving a first input comprising a selected base model from a plurality of base models;
receiving a second input comprising one or more selected transformer models;
collecting domain-specific text data;
curating multi-modal datasets using the one or more selected transformer models;
labeling the domain-specific text data and the multi-modal datasets using domain-specific metadata;
modifying the selected base model by freezing one or more large layers of the selected base model and fine-tuning one or more adapter layers of the selected base model;
training the modified base model using the labeled domain specific text data and the labeled multi-modal datasets using a transfer learning processes;
training an edge model using the trained, modified base model;
converting the edge model into executable code; and
storing the executable code in a memory.

9. The non-transitory computer-readable medium of claim 8, wherein the operations further comprise:
selecting edge hardware configured for artificial intelligence workloads;
deploying the executable code to the selected edge hardware;
generating an inference engine for routing inputs dynamically to an appropriate model; and
storing the inference engine on the selected edge hardware.

10. The non-transitory computer-readable medium of claim 9, further comprising:
storing one or more domain-specific documents in a vector database in the edge hardware;
retrieving relevant data from the vector database for real-time insights using retrieval-augmented processed; and
generating one or more results using the edge model and the retrieved relevant data.

11. The non-transitory computer-readable medium of claim 9, further comprising:
analyzing the one or more results to determine one or more anomalies;
generating an alert based on the one or more anomalies;
generating one or more recommendations based at least in part on the anomalies; and
sending the one or more recommendations to a user.

12. The non-transitory computer-readable medium of claim 9, wherein the fine-tuning uses Low-Rank Adaptation.

13. The non-transitory computer-readable medium of claim 9, wherein the fine-tuning uses Parameter-Efficient Fine-Tuning.

14. The non-transitory computer-readable medium of claim 9, wherein the fine-tuning utilizes at least one of text-based diagnostics, image and video based fault detection, and senor anomaly detection.

15. A system comprising:
one or more processors configured to access code stored in a memory to perform operations comprising:
receiving a first input comprising a selected base model from a plurality of base models;
receiving a second input comprising one or more selected transformer models;
collecting domain-specific text data;
curating multi-modal datasets using the one or more selected transformer models;
labeling the domain-specific text data and the multi-modal datasets using domain-specific metadata;
modifying the selected base model by freezing one or more large layers of the selected base model and fine-tuning one or more adapter layers of the selected base model;
training the modified base model using the labeled domain specific text data and the labeled multi-modal datasets using a transfer learning processes;
training an edge model using the trained, modified base model;
converting the edge model into executable code; and
storing the executable code in a memory.

16. The system of claim 15, wherein the operations further comprise:
selecting edge hardware configured for artificial intelligence workloads;
deploying the executable code to the selected edge hardware;
generating an inference engine for routing inputs dynamically to an appropriate model; and
storing the inference engine on the selected edge hardware.

17. The system of claim 16, wherein the operations further comprise:
storing one or more domain-specific documents in a vector database in the edge hardware;
retrieving relevant data from the vector database for real-time insights using retrieval-augmented processed; and
generating one or more results using the edge model and the retrieved relevant data.

18. The system of claim 17, wherein the operations further comprise:
analyzing the one or more results to determine one or more anomalies;
generating an alert based on the one or more anomalies;
generating one or more recommendations based at least in part on the anomalies; and
sending the one or more recommendations to a user.

19. The system of claim 15, wherein the fine-tuning uses Low-Rank Adaptation.

20. The system of claim 15, wherein the fine-tuning uses Parameter-Efficient Fine-Tuning.
